(19) United States
(12) Patent Application Publication
(10) Pub. No.: US 2013/0285453 A1
(43) Pub. Date: Oct. 31, 2013

(54) METHOD AND APPARATUS FOR SEAMLESS POWER TRANSFER

(71) Applicant: SUNSOURCE GRIDS, INC., Amherstburg (CA)

(72) Inventors: Marlon Glynn Hurst, Amherstburg (CA); Lakshmi Varaha Iyer, Windsor (CA); Xiaomin Lu, Windsor (CA); Narayan Chandra Kar, Windsor (CA); Maryam Kazerooni, Windsor (CA); Kaushik Mukherjee, Windsor (CA)

(73) Assignee: Sunsource Grids, Inc., Amherstburg (CA)

(21) Appl. No.: 13/869,141

(22) Filed: Apr. 24, 2013

Related U.S. Application Data
(60) Provisional application No. 61/638,573, filed on Apr. 26, 2012.

(51) Int. Cl. H02J 3/06

(52) U.S. Cl. CPC H02J 3/06
USPC 307/51

(57) ABSTRACT

A seamless power transfer apparatus comprising a solar grid and a utility power grid. The apparatus comprises a smart switch electrically connected to the solar grid and to the utility grid. The smart switch does not allow the solar grid to supply power to the utility power grid at any time.

This application claims benefit to U.S. Provisional Patent Application 61/638,573 filed on Apr. 26, 2012

### BACKGROUND OF THE INVENTION

1. Field of the Invention

The present invention generally relates to a method and apparatus for a seamless power transfer system, and more particularly, relates to a method and apparatus for a seamless power transfer system between a solar photovoltaic grid, end users and a power grid.

2. Description of Related Art

Electrical grids that provide power to businesses and personal buildings have been known for many years. Some of these prior art electrical grids transfer power from the utility grid operated by large utilities, states, etc., and feed consumers power to their houses or places of business. This power is generated by the utilities via hydro electric means, fossil fuel means, wind energy, solar energy, etc. These utility companies create the power at power plants and deliver the power via the utility grids to the end user in the form of personal households or commercial buildings. Solar panels in the form of solar grids are also well known in the prior art. The solar grids generally convert sunlight into electricity. The electricity from the solar panel may be directly connected to a single building or connected to a utility grid and sold back to a utility by the end user of the solar photovoltaic grid. These prior art electrical grid systems generally are reliable in supplying electrical power to individuals and businesses when required. However, many of these prior art electrical grid and utility grid systems are becoming taxed and overstressed, which may require the utility to shut down the grid via either rolling blackouts, brownouts or complete disruption in electrical power supplied to individuals and commercial buildings. As more and more electronic devices come online or on-grid, the ability for a utility to provide power when required at all times is becoming stretched. The use of alternative energy power grids by individuals or businesses, such as wind power, solar power, hydro power, etc., have some advantages, but the initial start up costs and unreliable power over a twenty four hour period makes these systems too expensive, not robust, and not reliable for every day use. In the case of wind power, if a day is calm and wind is not blowing, power generation ceases and electric power cannot be supplied to the user. In the case of solar grid electrical systems, if the sun is blocked by clouds for any period of time electric power is not capable of being sent to the end user.

Therefore, there is a need in the art for a system that uses power transfer from both an alternative energy source and a utility power grid to the end user. There also is a need in the art for an apparatus that may create seamless power transfer between a photovoltaic solar grid and an end user and between the end user and utility power grid. Furthermore, there is a need in the art for a power transfer system that may not disrupt the power to the electrical loads when switching between a solar photovoltaic grid and/or a utility grid and vise versa. There also is a need in the art for a low cost high reliability power transfer system that may allow for power transfer between a photovoltaic source and a utility grid. There also is a need in the art for a shared grid solution to overcome the over stressed and over taxed utility grids by combining these utility grids with independent photovoltaic or other alternate energy grid systems. There also is a need in the art for a shared grid solution that may allow for day light or solar producing hours to be on the solar or alternate electric grid, so the electrical load will not tax the utility grid and during non-producing solar hours the electric load for the building or household may be transferred to a local utility electric grid system in a seamless and non-disruptive manner.

### SUMMARY OF THE INVENTION

One object of the present invention may be to provide an improved power transfer system.

Another object of the present invention may be to provide an improved power transfer system that may provide for seamless power transfer between an alternate energy source grid, such as a solar photovoltaic grid and a utility grid, which generally is provided by a local energy company.

Still another object of the present invention may be to provide a power transfer system that may increase the usage of roof top solar panels.

Yet another object of the present invention may be to provide a seamless power transfer system that may integrate a new off grid system with a utility grid thus removing customer loads from the already stressed utility grid during peak usage time.

Yet another object of the present invention may be to provide a seamless power transfer system that is low in cost and may create jobs in the solar industry as roof top solar panels may need to be supplied because of the new product.

Still another object of the present invention may be to provide a seamless power transfer system that may create substantial savings in energy costs for high usage corporations, school boards, public housing, etc.

Still another object of the present invention may be to provide a seamless power transfer system that may create less stress on the utility grids of local utilities.

Still another object of the present invention may be to provide a seamless power transfer system that may increase diversity in the economy while also bringing substantial savings to home and business owners.

Still another object of the present invention may be to provide a seamless power transfer system that uses photovoltaic solar panels in conjunction with a utility grid and a smart power transfer switch to seamlessly transfer the electrical loads between the photovoltaic grid and the utility grid without brownouts or any discernable power fluctuation by the end user.

According to the present invention, the foregoing and other objects and advantages are obtained by a novel design and methodology for a seamless power transfer system. The seamless power transfer system may include a photovoltaic solar grid used in conjunction with a utility power grid. The utility power grid and the solar photovoltaic grid, wherein the solar photovoltaic grid is local to the building using the power transfer system, are connected or in communication with one another via a smart switch. The smart switch may be in the form of a controller that may control the solar photovoltaic panels, grid fed inverter or power electronic converter. The controller may also control the switching of two contactors, wherein one of the contactors is connected to the utility grid side of the switch and the second contactor is connected to the photovoltaic grid side of the switch. The controller may have a methodology to determine if the photovoltaic solar panel base grid has the necessary power output to supply the number of electrical loads needed by the end user. If the power output from the photovoltaic solar panel grid system is too low or not available, the loads may then be supplied fully from the utility grid until enough power out from the photovoltaic solar grid is available. The controller may be able to determine when the switch from the photovoltaic grid power output should be made to the utility grid side power output such that the existing electrical loads do not encounter a power outage when the transition occurs in either direction, i.e., from the photovoltaic grid side to the utility grid side or from the utility grid side to the photovoltaic grid side of the power transfer system. The power transfer system of the present invention is not a full stand alone photovoltaic system nor a full grid tie inverter based system but rather a hybrid of these two systems in which the solar photovoltaic base grid may never supply power to the utility grid. The power transfer system of the present invention uses its design, simulation and hardware implementation with the proper real time control strategy, which may regulate the transitions between the two grid systems depending on the solar photovoltaic system and the loading conditions required thereof.

One advantage of the present invention may be that it provides for an improved power transfer system.

A further advantage of the present invention may be that it provides for an improved power transfer system that creates a seamless power transfer system between a solar photovoltaic grid and an end user and between an end user and a utility grid.

Still another advantage of the present invention may be that it provides a power transfer system that may increase the usage of roof top solar panels.

Still another advantage of the present invention may be that it provides a power transfer system that may integrate an off grid secondary power system with the utility grid, thus removing customer loads from the already stressed utility grid during peak usage time.

Still another advantage of the present invention may be that it provides a power transfer system that may create jobs in the solar industries because the need for roof top solar panels may increase because of new product installation.

Still another advantage of the present invention may be that it provides a power transfer system that may create substantial savings and energy costs for high usage corporations, school boards, public housing, individuals, etc.

Still another advantage of the present invention may be that the power transfer system may eliminate rolling blackouts and brownouts through the use of this new technology on a utility grid.

Still another advantage of the present invention may be that the power transfer system provides for an improved power transfer that may create less stress on the utility grid.

Still another advantage of the present invention may be that it provides a seamless power transfer system that increases the diversity in the economy of power supplying and create substantial savings to home and business owners.

Still another advantage of the present invention may be that it provides for a seamless power transfer system that is low cost, low maintenance and greatly reduces energy costs to the end user.

Other objects, features and advantages of the present invention may become apparent from the subsequent description and appended claims, taken in conjunction with the accompanying drawings.

### BRIEF DESCRIPTION OF THE DRAWINGS

FIG. 1 shows a schematic block diagram of the seamless power transfer system according to the present invention.

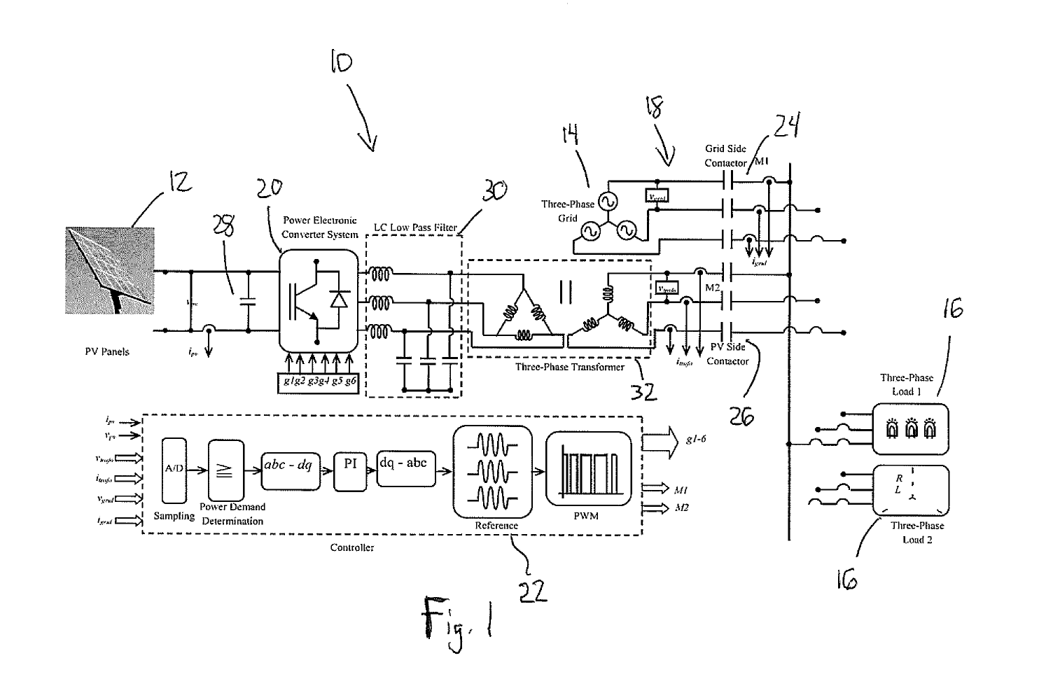

FIG. 2 shows a block diagram of one contemplated embodiment of a control methodology of the inverter fed from the solar photovoltaic source/grid.

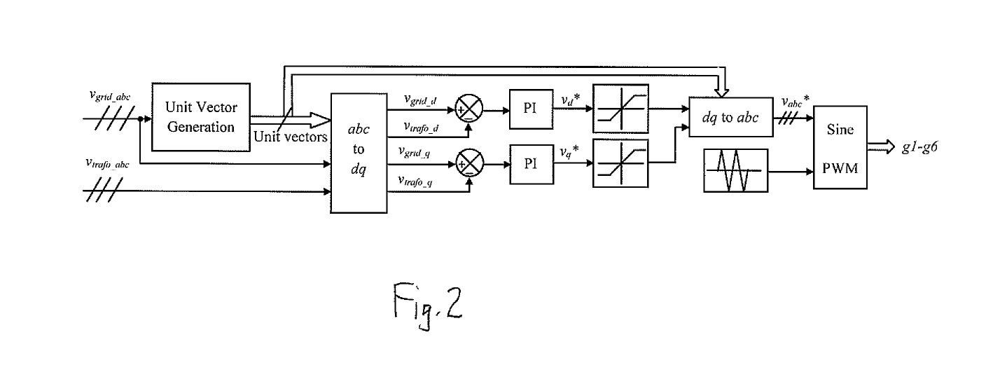

FIG. 3 shows a block diagram of one contemplated embodiment of a control methodology for switching between contactor M1, which is connected to the utility grid side and contractor M2 which is connected to the photovoltaic grid side.

FIG. 4 shows a black diagram of one contemplated embodiment of a control methodology for a seamless power transfer system according to the present invention.

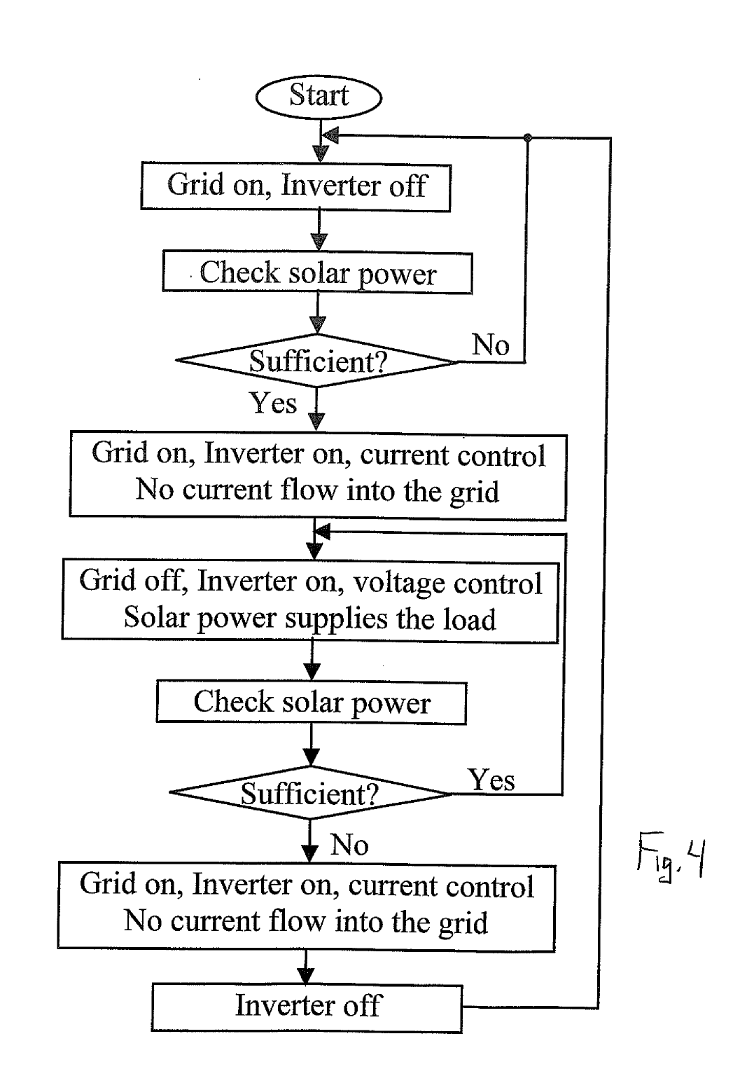

### BRIEF DESCRIPTION OF THE EMBODIMENT(S)

Referring to the drawings, there is shown a seamless power transfer system 10 according to an embodiment of the present invention. The power transfer system 10 of the present invention may create a seamless power transfer mechanism between a solar photovoltaic grid 12 or source 12 to an end user and between an end user and an electric utility power grid 14 ran by a local utility company. The seamless power transfer 10 from the utility grid 14 and/or a solar photovoltaic grid 12 to electrical loads 16 may occur without disrupting the power to the electrical loads 16. Any known suitable photovoltaic based power supply system may be used including small laboratory scale systems, such as a controlled 3-phase 60 Hz AC power supply system that has a nominal 1.5 kW power and/or including large kW systems to be used on commercial buildings or individual buildings in conjunction with a local utility grid 14. The use of this system 10 on higher power voltage levels may be useful for improving energy production, conversion and conservation in buildings throughout all nations in the world with the goal of moving toward a near net zero building and communities when it comes to power supply. It is also contemplated to have the power transfer system 10 of the present invention to be available in a portable or mobile system. This may allow for a compact array of photovoltaic solar panels 12 to be moved to predetermined areas for temporary onsite power that is capable of being directly attached via the switch 18 of the power transfer system 10 of the present invention to the local utility grid 14. This may allow for festivals or other temporary structures, etc., to have a hybrid power system that is capable of providing enough power on its own via a photovoltaic grid 12 and if such power is not available because of atmospheric conditions the system 10 may switch to the utility grid 14, thus creating seamless power to the electrical loads of the temporary site.

As shown in the figures, one embodiment of the present invention may include a plurality of photovoltaic panels 12 which may or may not be installed at the building or site where the seamless power transfer system 10 may be used. These photovoltaic panels 12 may be arranged and installed using any known prior art methodology or technique. This may include but is not limited to installing solar panels 12 on roof tops, on swinging arms, in open fields, adjacent to a building, or in any other known manner capable of using photovoltaic solar panels 12. The photovoltaic panels 12 are connected to one another into a grid with the necessary cabling, wiring and characterizations of an installed photovoltaic base grid 12 into the stand alone power electronic system of the present invention. Any number of a plurality of electrical loads 16, which generally would be representative of a household or a building, may be supplied fully from the utility grid side 14 of the seamless power transfer system 10 according to the present invention. This full supply from the utility grid 14 may occur when the power output from the photovoltaic based grid 14 may be too low or non-existent/absent. However, if the electric loads 16 connected to the power transfer system 10 of the present invention may be capable of being supplied fully from the photovoltaic based grid 12 such power supply may occur. The use of the seamless power transfer system 10 of the present invention may allow that the existing electrical loads 16 may not face a power outage when the transition occurs in either direction, i.e., between the utility grid side 14 of the switch or the photovoltaic grid side 12 of the switch during the process of load transfer from or to the utility grid 14 to the photovoltaic base grid 12. Therefore, the power transfer system 10 is neither a full stand alone or a full grid tie inverter based system as generally are found in the prior art. This power system 10 according to the present invention may be a hybrid of these two methodologies in which the solar based grid 12 may never supply power to the utility grid 14. The unique design of the power transfer system 10 of the present invention along with simulation and hardware implementation of this concept in a real time control strategy allows the present invention to regulate the transitions depending on the solar cells and solar energy available and the loading conditions.

In one contemplated embodiment a plurality of power photovoltaic panels 12 may be used to create the power photovoltaic grid side 12 of the system 10. Electrical loads 16 may be connected to the photovoltaic solar grid side 12 of the system and the utility grid side 14 of the system via a switch 18. In one contemplated embodiment, which may create a test power transfer system 10 according to the present invention a grid tie based inverter may be connected to the photovoltaic panels 12 and characterizations performed thereon such that an active load may occur on the photovoltaic panel grid 12. The power transfer system 10 of the present invention also may include in one contemplated embodiment the ability to keep the voltage across the DC link capacitor stabilized for a longer duration of time due to varying atmospheric conditions, such that a boost converter may be connected at the front end of the power electronic converter system 20 with its control being controlled by the controller 22 of the system. The power transfer system 10 of the present invention also may include a rear end inverter of the power electronic converter system 20, magnetic components, switchgear devices, capacitors and other electrical components.

The power transfer system 10 of the present invention generally includes the photovoltaic grid 12 connected or in communication with the utility grid 14 which generally is a three phase grid. These grids 12, 14 are connected to one another via a first grid side contactor 24 M1 which is connected to the utility grid 14 and a second photovoltaic side contactor 26 M2 which is connected to the photovoltaic side 12 of the system 10. The photovoltaic panels 12 are electrically connected to a power electronic converter system 20 with the requisite capacitors 28 and other electrical components arranged therebetween. The power electronic converter system 20 of the present invention has its output electrically connected to a LC low pass filter 30. The low pass filter 30 is also electrically connected to and may pass a predetermined signal onto a three phase transformer 32 which will then electrically connect directly into the M2 contactor 26 on the photovoltaic side 12 of the switch. The system 10 may also include a controller 22 that may sample the voltage (Vₚᵥ) and current (iₚᵥ) of the photovoltaic panels, the filtered induced inverter output voltage (V_{trafo}) and current (i_{trafo}) and the utility grid voltage (V_{grid}) and current (L_{grid}). The controller 22 may use this information and determine if the photovoltaic solar panel side 12 of the system is capable of providing enough power for the requisite electrical loads 16 on the system 10. If it is, contactor 26 M2 may pass the power through from the photovoltaic grid 12 to the necessary loads 16 and the utility contactor 24 M1 may be opened/not transfer power.

The controller 22 of the power transfer system 10 according to the present invention may control all activities of the switch and the power transfer between the solar grid side 12 of the system and the utility grid side 14 of the system. Generally this controller 22 may use a methodology divided into two parts, the first being the control of the solar photovoltaic fed inverter, i.e., power electronic converter 20 and the control of the switching of the two contactors 24, 26 M1 relating to the utility grid side 14 and M2 relating to the photovoltaic solar panel side 12. Generally, the solar photovoltaic fed power electronic converter output may be controlled such that the V_{trafo} tracks V_{grid} online with almost zero steady state error, almost zero overshoots/undershoots and in as less a settling time as possible. This may allow the controller 22 to be effective over a range of solar photovoltaic output voltages, which may be dictated by atmospheric conditions and the total load on the system 10. If the solar photovoltaic output voltage V_{trafo} falls within a predetermined range, the load 16 may be supplied from the solar photovoltaic side 12 of the system 10 through contactor 26 M2. It should be noted that a d-q theory based decoupled field oriented/vector control principle may be used to control the inverter output which may eventually dictate the value V_{trafo}. It should further be noted that other methodologies may be used to control and regulate the inverter output and hence the value V_{trafo}. The use of this d-q theory principle may be the same as that used in a rotating electrical machine drive and may be applied in the static system of the present invention which may control the inverter output which may eventually dictate the output voltage from the photovoltaic side 12 of the system 10 as described above. Hence, when the solar photovoltaic output voltage may be outside of a predetermined referred range, contactor 24 M1 may be controlled to close and contactor 26 M2 to open so that the load 16 may be supplied from the utility grid 14. The controller methodology may also determine if the inverter fed voltage will create enough power to supply other electrical loads 16 on the system 10 via the photovoltaic grid side 12 of the system.

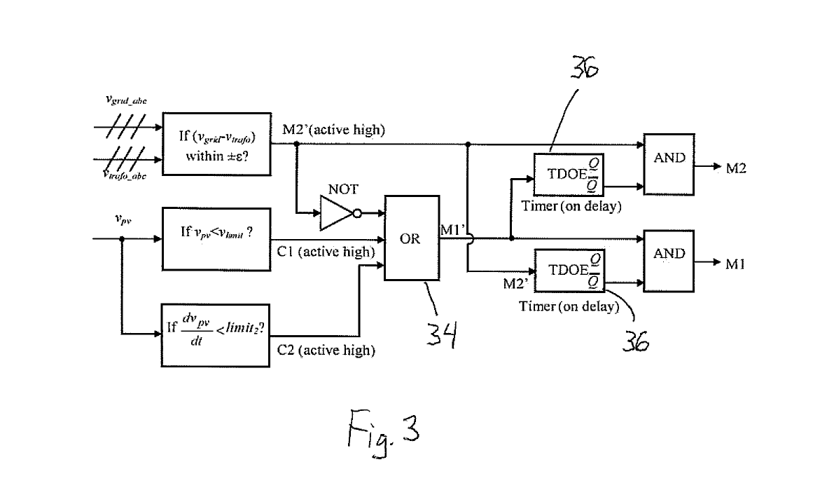

One contemplated methodology for the switching between the two contactors 24, 26 M1 and M2 of the system 10 may use and measure the filtered boosted inverter output voltage V_{trafo} and the grid voltage V_{grid} online continuously. A predetermined small limit (ε) may be set for the difference between these two voltages. If the measured difference lies within this small limit (ε), only then will contactor M2 be made to be on or active high otherwise it will not be on. Also, in the methodology, the photovoltaic output voltage (Vₚᵥ) may also be measured online and the time rate of variation dvₚᵥ may be computed in real time. The methodology will set a predetermined limit Vₗᵢₘᵢₜ on the photovoltaic output voltage Vₚᵥ and then if the actual photovoltaic output voltage goes below or is less than Vₗᵢₘᵢₜ it will be treated as an indicator denoting tendency towards out of range operation of the inverter, which is manifested through the state of the Boolean variable C1, which will be turned on or set to active high and sent to an OR gate 34. Furthermore in the methodology, a second predetermined limit (limit₂) may also be set for the time rate of fall of the photovoltaic output voltage Vₚᵥ. When the actual time rate of change of the photovoltaic output voltage Vₚᵥ is below the predetermined set limit₂, another predictive tendency towards out of range operation of the inverter may occur and is represented through the state of the Boolean variable C2 which will be turned on or set to active high and then set to OR gate 34. In either of these cases of solar conditions not suitable, i.e., variable C1 or variable C2 active high, contactor 24 M1 connected to the utility grid side 14 may be on and contractor 26 M2 connected to the solar grid 12 may remain off with no power being transferred therethrough. These may be ensured by the logic gates as shown in FIG. 3. If favorable conditions occur for the photovoltaic output voltages Vₚᵥ and V_{trafo} and the loading, the logic gates may ensure that M2 will be on and M1 will be off. This may allow for voltage to flow from the photovoltaic side 12 creating the power necessary for the electric loads 16 connected thereto. The methodology also includes two on delay timer logic gates or members 36 (time delay on energization) as shown in FIG. 3. The gates 36 handle the situation where for a small time during transition from contactor 24 M1 to contactor 26 M2 and vice versa that an overlap may be maintained so that the load 16 does not see a power blackout or brownout during such transfer between M1 and M2. It should be noted that other methodologies are contemplated and may be developed to control the power switching between the utility grid 14 and the photovoltaic solar grid 12 of the power control system 16 according to the present invention. Other methodologies and apparatuses, other than those shown in the figures or disclosed herein, are contemplated for controlling the seamless transfer between the utility grid side 14 of the system 10 and the photovoltaic solar panel side 12 of the system 10.

The present invention has been described in an illustrative manner. It is to be understood that the terminology, which has been used, is intended to be in the nature of words of description rather than that of limitation.

Many modifications and variations of the present invention are possible in light of the above teachings. Therefore, within the scope of the appended claims, the present invention may be practiced otherwise than as specifically described.

What is claimed is:

1. A seamless power transfer apparatus, said apparatus comprising:
a solar grid and a utility power grid;
a smart switch electrically connected to said solar grid and to said utility power grid; and
said smart switch does not allow said solar grid to supply power to said utility power grid.

2. The apparatus of claim 1 wherein said smart switch having a DC-DC converter electrically connected to said solar grid.

3. The apparatus of claim 2 wherein said smart switch having a DC-AC inverter electrically connected to said DC-DC converter.

4. The apparatus of claim 3 wherein said smart switch having a low pass filter electrically connected to said DC-AC inverter.

5. The apparatus of claim 4 wherein said smart switch having a transformer electrically connected to said low pass filter.

6. The apparatus of claim 5 wherein said smart switch having a first contactor electrically connected to said transformer and a load.

7. The apparatus of claim 6 wherein said smart switch having a second contactor electrically connected to said utility power grid and said load.

8. The apparatus of claim 7 wherein said smart switch having a controller which ensures said load does not encounter a power blackout when a transition occurs between power being supplied by said solar grid and said utility power grid.

9. The apparatus of claim 8 wherein said controller allows power to be supplied to said load from said solar grid when a power output from said solar grid is sufficient to satisfy a power need for said load.

10. The apparatus of claim 9 wherein said controller allows power to be supplied to said load from said utility power grid when said solar grid power output is insufficient to satisfy said power need for said load.

11. A method of transferring power seamlessly to a load from either a first or second grid, said method comprising the steps of:
initializing a controller;
determining if a power output of the first grid is greater than or equal to a predetermined value;
transferring power from said first grid to the load as long as said power output of said first grid is greater than or equal to said predetermined value;
transferring power from said second grid to the load when said power output of said first grid is less than said predetermined value; and
stopping current flow from said first grid to said second grid.

12. The method of claim 11 wherein said first grid is a solar photovoltaic grid.

13. The method of claim 11 wherein said second grid is a utility power grid.

14. The method of claim 11 further comprising the step of allowing power to flow from said second grid and turning off a DC-AC inverter on said first grid.

15. The method of claim 11 further comprising the step of determining an actual value for said power output of the first grid.

16. The method of claim 11 further comprising the step of turning on a DC-AC inverter of the first grid if said power output of the first grid is greater than or equal to said predetermined value.

17. The method of claim 11 further comprising the step of stopping power from flowing from the second grid and allowing the first grid to supply power to said load.

18. The method of claim 11 further comprising the step of activating the second grid if said power output of said first grid is less than said predetermined value.

19. The method of claim 11 wherein said transferring steps occur without a power blackout on the load.

20. The method of claim 11 further comprising the step of keeping power from being injected or transferred from said first grid to said second grid at all times.
